(19) United States
(12) Patent Application Publication
(10) Pub. No.: US 2007/0149141 A1
(43) Pub. Date: Jun. 28, 2007

(54) Method for operating a transmitting device and working transmitting device

(75) Inventors: Uli Joos, Nonnenhorn (DE); Heinrich Haas, Meckenbeuren (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/554,485

(22) PCT Filed: Apr. 14, 2004
(86) PCT No.: PCT/DE04/00773

§ 371 Date: Oct. 27, 2006

(30) Foreign Application Priority Data
Apr. 25, 2003 (DE) 103 18 727.8
Mar. 11, 2004 (DE) 102004011926.0

(51) Int. Cl. H04B 1/38; G08C 19/00

(52) U.S. Cl. 455/73; 340/825.72

(57) ABSTRACT

Disclosed are a transmitting device and a method for operating the transmitting device. The device includes long wave antennas, a multiplexer for activating an antenna, a power amplifier connected to a group of antennas and control unit for regulating the transmitter current.

### BACKGROUND OF THE INVENTION

The invention refers to a method for operating a transmitting device with a plurality of longwave antennas of an access system of a vehicle, in particular of a motor vehicle. It further refers to a transmitting device working accordingly.

An access system of this type, which often is referred to as passive access system (passive entry system), usually forms part of a higher-ranking keyless remote control system, which in addition to the automatic release of a vehicle door also controls its motor starting system and/or an anti-theft device. Such system comprises a transmitting device or transponder, integrated for instance into the vehicle key and carried along by a person authorized for the vehicle, and a vehicle based transceiver.

For ascertaining an access authorization to the vehicle between the portable transponder and the vehicle based transceiver redundant codes or access data are exchanged based on high-frequency (HF) and/or low-frequency (LF)—and thus short-wave or long-wave carrier signals. Local detection of the transponder is performed via divers longwave antennas arranged in or distributed all-over the vehicle.

According to a passive remote control system known from DE 101 08 578 A1 the longwave antennas can be sequentially activated by a vehicle based control system. In case of the known system the transponder answers to such a longwave-based interrogating signal with a redundant-coded HF-signal for identifying the access authorization. Where applicable, a vehicle-based control system unlocks the vehicle door, so that it can be opened by manually operating the door handle.

By sequentially activating the longwave antennas, in fact, the energy to be delivered by the vehicle battery for triggering the longwave antennas can be kept low. However, according to a keyless access system known from DE 198 35 155 A1 the transmitter antennas are usually individually triggered by means of separate drivers, resulting in a considerable circuit expenditure in particular with high requirements to the driver output stage.

### SUMMARY OF THE INVENTION

It is, therefore, the object of the invention to indicate a method of the type mentioned above, which allows for a preferably low-loss triggering of a plurality of longwave transmitter antennas of a transmitting device of a vehicle access system. Furthermore, a transmitting device, in particular for the door control of a motor vehicle shall be indicated which is particularly suitable for implementing the method.

The invention is achieved by the features of a transmitting device and a method for operating the transmitting device. The device includes long wave antennas, a multiplexer for activating an antenna, a power amplifier connected to a group of antennas and control unit for regulating the transmitter current.

The advantages achieved with the invention are in particular that by direct triggering of all longwave-transmitter antennas jointly and their individual activation by means of a multiplexer device a reliable transmitting operation is achieved with a circuit or component arrangement which simultaneously requires particularly low space and thus is effective. By the direct triggering of the longwave transmitter antennas on the one hand a particularly reliable local detection and on the other hand a particularly reliable energy transmission in a transponder, in particular an intelligent vehicle key, is achieved.

By using a power amplifier with limited rise time and optimized saturation behavior, furthermore particularly low-loss triggering with simultaneous restriction of the electromagnetic radiation to a reliable value without additional filter measures at the amplifier outlet is achieved.

Further, by the direct triggering of the longwave transmitter antennas formed by transmitter coils in series resonance, by means of a trapezoidal voltage the circuit expenditure and thus the cost expenditure is particularly low, especially as several transmitting devices can be triggered from a central control device and the transmitter antennas can be connected directly to the amplifier outlet.

Moreover, by controlling the sinusoidal transmitter current while restricting its peak value by means of a fast power off and by a synchronization by pulse-width modulation at the control input of the amplifier its output power can be steadily adjusted to a particularly high activity value. This allows for operating the amplifier output stage in saturated manner, so that in its driver or driver stage there is only a low power loss.

### BRIEF DESCRIPTION OF THE DRAWINGS

An example of embodiment of the invention is explained in detail in the following taken in conjunction with the drawing.

FIG. 1 shows schematically in a block diagram the circuit of a transmitting device with an individual amplifier and a plurality of transmitter antennas,

FIG. 2 shows a comparatively detailed circuit of the block diagram according to FIG. 1,

FIG. 3 shows a signal diagram for illustrating the functionality of a current regulation of the transmitting device, and

FIG. 4 shows a circuit principle of the amplifier of the transmitting device.

In all figures like elements refer to identical reference numerals.

### DETAILED DESCRIPTION OF THE DRAWINGS

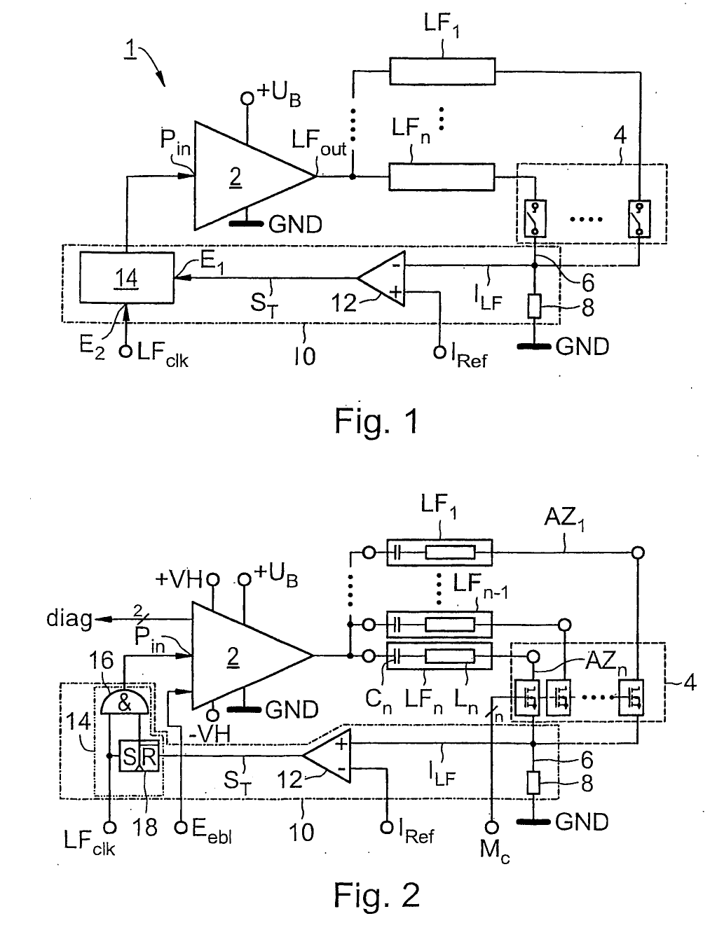

FIG. 1 shows schematically in a block diagram a transmitting device 1, which for instance is part of a door control of a motor vehicle access system. The transmitting device 1 comprises an amplifier device in form of a central amplifier 2, whose operating voltage U_{B} is delivered by the vehicle battery (not shown). At the outlets LFₒᵤₜ of the amplifier 2 a plurality of longwave transmitter antennas LF_{1 . . . n,} hereinafter referred to as antennas, are directly and jointly connected. The antennas LF_{1 . . . n} are individually activated by a multiplexer device or a multiplexer 4 and are connected at a certain order and time sequence and thus are successively activated. For this purpose the multiplexer device 4 connected downstream of the antennas LF_{1 . . . n} is connected against ground GND.

In the ground branch 6 of the multiplexer 4 a shunt 8 for measuring current is connected, which forms part of a current regulation 10. The current regulation 10 comprises a current detector 12 in the form of an over-current comparator, to the one input thereof—here the (+) input—a referential signal I_{Ref} and to the other input thereof—here the (−) input—a transmitter current I_{LF} guided via the antennas LF_{1 . . . n} and the multiplexer 4 is supplied.

On the output side the current detector 12 is connected to an input E₁ of a control logistics 14, at the second input E₂ thereof a low-frequent clock signal LF_{clk} with a frequency of advantageously 125 kHz is guided. On the output side the control logistics 14 is connected to a control input Pᵢₙ of the amplifier 2.

When operating the transmitting device 1 the amplifier 2 triggered on the input side with the low-frequent trigger signal LF_{clk} produces on the output side a trapezoidal voltage, which is used via the amplifier outlet LFₒᵤₜ directly for jointly triggering the antennas LF_{1 . . . n}. Here, the antennas LF_{1 . . . n} are successively connected to the amplifier 2 by means of the multiplexer 4 in a time sequence capable of being predetermined. This allows for a particularly low-loss triggering.

The transmitter current I_{LF} guided via the respectively activated antenna LFₙ is detected by means of the shunt 8 at the multiplexer 4 on the ground side and is supplied to the (−)-input of the current detector 12 hereinafter referred to as over-current comparator. This over-current comparator compares the transmitter current I_{LF} with the referential value I_{Ref}. When the referential value I_{Ref} has been exceeded current restriction of the transmitter current I_{LF} is effected by means of the current regulation 10 to the referential value I_{Ref} capable of being predetermined, which represents the desired value of the current regulation 10. For this purpose the over-current comparator 12 produces on the output side a control or trigger signal S_{T}, which is supplied via the control logistics 14 to the input Pᵢₙ of the amplifier 2 for controlling the output power of its output stage. With a corresponding Q of the transmitting device 1 effective as a transmitting circle this causes the actual value of the transmitter current I_{LF} to be adapted with good approximation to the desired value I_{Ref}.

As can be seen from the comparatively detailed circuit according to FIG. 2, each longwave-transmitter antenna LFₙ is embodied as a transmitter coil Lₙ, which is coordinated to series resonance by means of a condenser Cₙ which is series connected to this transmitter coil Lₙ. The multiplexer 4, downstream connected to the antennas LFₙ, which by means of square wave voltage are directly triggered by the amplifier 2, is advantageously embodied in MOSFET-technology.

For this purpose the multiplexer 4 comprises in each antenna branch AZ₁ to AZₙ a power transistor (MOSFET), which is triggered on the gate side by means of a corresponding control signal M_{c} for activating the respective antenna LFₙ. As a result, merely the power transistor, respectively triggered, of the multiplexer 4 guides the (entire) transmitter current I_{LF} due to the triggering of the antenna LFₙ arranged in the corresponding antenna branch AZₙ by means of square wave voltage produced by the amplifier 2. The embodiment of the multiplexer 4 in SMART-MOSFET-technology advantageously produces a resistance of the arrangement against short-circuits of the antenna lines, with conventional MOSFETs particularly fast triggerings, e.g. for fast phase modulation, can be achieved.

Basically, also divers antennas can be operated at the same time, however, in this case only the cumulative current would be controlled.

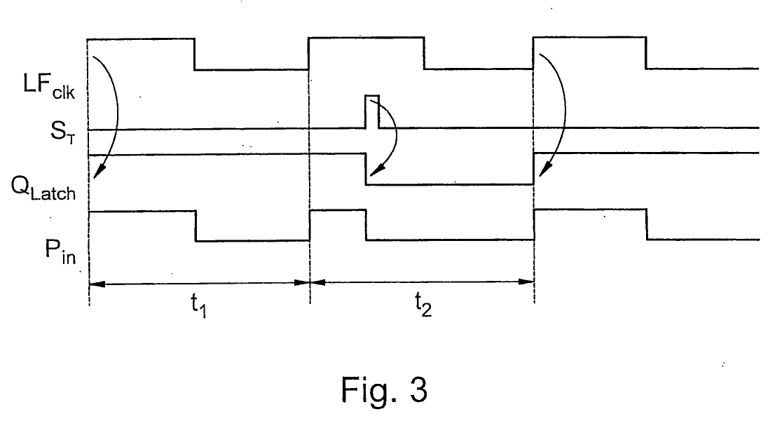

According to FIG. 2 the control logistics 14 is composed of a logical AND-element or -gate 16 and of a sequential circuit hereinafter referred to as PWM-latch. Advantageously, this is embodied as a flank controlled D-flipflop (latch-flipflop), which according to the signal diagram in FIG. 3 triggers onto the positive flank of the clock signal LF_{clk}. This PWM-latch thus serves for synchronizing the control or trigger pulse S_{T} with the clock LF_{clk} and for pulse-width modulation (PWM) of the input signal Pᵢₙ of the amplifier 2. This results in that the sinusoidal transmitter current I_{LF}—and the transmitting power—are regulated by peak value restriction of the transmitter current I^{LF} by means of a fast power off and a pulse-width modulation synchronization.

To this end the control signal or trigger pulse S_{T}, delivered by the over-current comparator 12 on the output side, which signal S_{T} is formed by comparing the transmitter current I_{LF}, measured in the ground branch 6 of the multiplexer 4, with the desired or referential value I_{Ref}, is used for triggering the PWM-latches 18.

As is illustrated in FIG. 3, here, the over-current comparator 12 does not trigger and the PWM-latch 18 continues to be set over the period referred to as t₁ (Q_{Latch}=high), as long as the referential value R_{Ref} predetermining the maximum value of the transmitter current I_{LF} is not exceeded. With that the input clock LF_{clk} (50% duty cycle) is applied at the input Pᵢₙ of the amplifier 2 and its output stage controls the complete output power.

If, however, the transmitter current I_{LF} exceeded the maximum or peak value predetermined by the referential value I_{Ref}, the over-current comparator 12 switches and the thus produced control signal S_{T} resets—in the illustrated period t₂—the PWM-latch 18 (Q_{latch}=low). Based on the linkage with the clock signal LF_{clk} serving as an input clock by means of the AND-gate 16, the pulse width at the input Pᵢₙ of the amplifier 2 is modulated such that the maximum or peak value of the transmitter current I_{LF} corresponds at least approximately to the referential or desired value I_{Ref}. By this short-circuit protection the transmitting device 1 cannot only be used in a door control system, but rather also in a central control system, which in addition to the access system comprises also a motor starting control and/or an anti-theft device of the vehicle.

The amplifier 2 can be deactivated via an ENABLE-input E_{ebl}, so that current consumption in the idle state of the transmitting device 1 is negligible low.

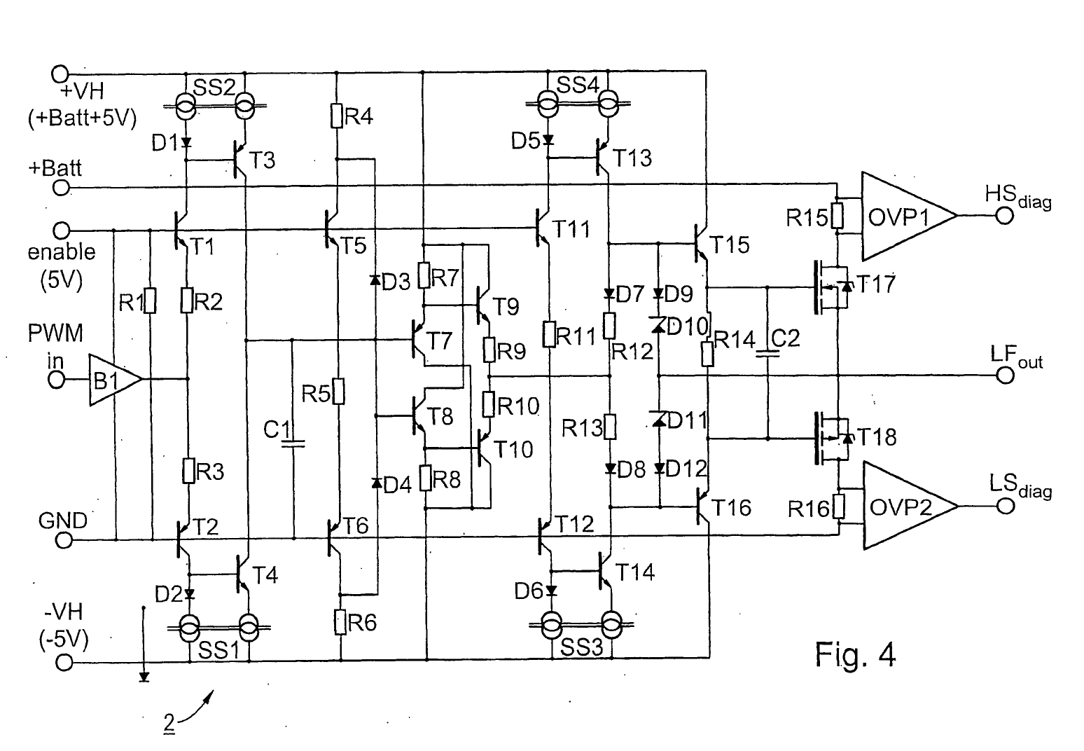

In accordance with the illustration in FIG. 4 the amplifier 2 is embodied as a source follower and thus as a power amplifier with MOF field effect transistors (MOSFET's) in drain circuit. By this embodiment of the amplifier 2 and thus of the joint driver output stage for all transmitter antennas LF_{1 . . . n} the rise time of the square wave or trapezoidal output voltage at the outlet LFₒᵤₜ of the amplifier 2 or of its output stage is restricted. By means of this the electromagnetic radiation and thus the electromagnetic compatibility (EMV) is kept particularly low. A further restriction of the electromagnetic radiation or EMV is advantageously achieved by a proper edge shaping the preferably trapezoidal or square wave output voltage (LFₒᵤₜ).

For this purpose the input signal PWMᵢₙ delivered by the control logistics 14 of the regulation device 10 at the input Pᵢₙ of the power amplifier 2 is converted into referential currents via a buffer B1 and two basic circuits formed by the resistance R2 and the transistor T1 as well as the resistance R3 and the transistor T2. They are mirrored with current mirrors SS1, SS2 each at the highest or lowest potential (+VH=U_{B}+5V), (−VH=−5V). The current mirrors SS1 and SS2 connected to the respective power supplies +VH and −VH of the amplifier 2 are current-controlled current sources, which transfer the current impressed on the input side into the condenser C1.

The (mirrored) referential currents charge the condenser C1 via the cascode steps formed by the diode D1 and the transistor T3 or the diode D2 and the transistor T4, the potential at the condenser C1 changing between approximately the potentials +VH and −VH. Here, the slew rate of the charging voltage at the condenser C1 is adjusted with the resistances R2, R3 and with the capacity of the condenser C1. With a network formed by the transistors T5, T6 and the diodes D3, D4 and the resistances R4, R5, R6 the voltage ramp at the condenser C1 can be decelerated (edge shaping) additionally in the region of the supply voltages +VH and −VH.

By the shown interconnection of the transistors T7 to T10 with the resistances R7 to R10 a current amplifier is formed, which decouples the voltage at the condenser C1 and triggers an output stage driver T15, T16. For this purpose the transistors T11 and T12 and the resistance R11 form a switchable current source, whose output current is mirrored with the two current mirrors SS3 and SS4 at the highest or lowest potential +VH or −VH, respectively and is decoupled via the cascode step formed by the diode D5 and the transistor T13 and the diode D6 and the transistor T14, respectively. The current mirrors with cascode (SS1, D2, T4; SS2, D1, T3; SS3, D6, T14; SS4, D5, T13) offer the advantage of high output resistances and high amplifications in the respective driver stages T7 to T10 and T15, T16 of the amplifier device 2.

The decoupled symmetrical current flows through a network formed by the diodes D7, D8 and the resistances R12, R13 and thus produces an offset voltage for triggering the control inputs of the output stage of the amplifier 2. The output stage is formed by MOS field effect transistors T17 and T18 in source-follower configuration, so that the offset voltage triggers their gates. By the constant powering of this network D7, R12; D8, R13 the gate voltage offset remains constant over the entire range of the triggering, merely the center voltage having to be controlled at the resistances R12 and R13 by the current amplifier T7 to T10, R7 to R10.

If the resistances R12 and R13 are substituted by a network with temperature-sensitive resistances, in particular by NTC-resistances with negative temperature coefficients, the offset can be affected such that the cross flow in the outlet or output stage formed by the MOSFET's T17 and T18 remains almost constant over a large temperature range. Alternatively, this property can also be achieved by controlling the respective referential current depending on temperature. For this purpose either the resistance R11 can be substituted by a temperature-sensitive resistance or the basic voltage at the transistor T11 can be modulated by an external control device.

The offset voltage controls via the emitter follower formed by the transistors T15 and 16 directly the respective gate of the output stage transistors T17 and T18. Here, it is ensured by a network formed by the resistance R14 and the condenser C2 that the gates of the output transistors T17 and T18 can be moved dynamically in both directions. Instead of this network R14, C2 alternatively also complementary followers for triggering the output stage transistors T17, T18 can be used. With a clamping network formed by the diodes D9 to D12 it is ensured that in the event of a short-circuit at the amplifier outlet LFₒᵤₜ the maximum admissible gate-source-voltage of the output transistors T17, T18 is not exceeded and that for this reason they cannot be destroyed.

Via operational amplifiers OPV1 or OPVs connected with the resistances R15 and R16 the currents in the output paths of the output stage transistors T17 or T18 are measured and are monitored for diagnostic purposes. By an appropriate linkage of the detected currents value with the transmitter current I_{LF} the output stage formed by the two output transistors T17 and T18 can be protected against thermal destruction in the event of a short-circuit or an overload at the outlet LFₒᵤₜ and against an excessive cross flow in the output stage T17, T18.

The 5V-ENABLE input serving for deactivating the power amplifier 2 shuts down the current sources of the basic circuit comprising the transistor T1 and of the network comprising the transistor T5 and the of switchable current source comprising the transistor T1. In the deactivated state of the power amplifier 2 (ENABLE=low) these current sources are deactivated and thus the output stage transistors T17, T18 are high-impedance switched.

By the current measurement diagnosis signals HS_{diag} or LS_{diag} generated in the in the outlet or output stage transistors T17 and T18 are supplied to a control device (not shown), which protects the power amplifier 2 in the event of a short-circuit or an overload at the outlet LFₒᵤₜ and/or against increased cross flow.

By using a power amplifier 2 of this type with restricted rise time and particularly favorable saturation behavior the electromagnetic radiation is restricted to reliable values without additional filter measures at the outlet LFₒᵤₜ. Here, by a symmetric embodiment of the circuit flanks the slew rate of the square wave or trapezoidal output voltage of the power amplifier 2 can be largely reduced while avoiding impact on the properties of the transmitter current regulation 10. With this active impact on the circuit flanks the electromagnetic radiation of the transmitting amplifier 1 and thus of the transmitting device 1 is minimized.

All in all by using merely one single power amplifier 2 for jointly triggering the plurality of longwave-transmitter antennas LF_{1 . . . n} the amplifier properties are particularly favorable while avoiding an ineffective increase of the total expenditure. In particular, by the active impact on the circuit flanks, i.e. restriction of the rise time and of edge shaping of the square wave or trapezoidal output voltage of the power amplifier 2 the transmitting device 1 can be operated without additional filter expenditure in a motor vehicle. Here, the electromagnetic radiation can be kept particularly low.

In relation to a sinusoidal triggering of a transmitting device in the longwave region, whose transmitter coil is operated in parallel or series resonance, the described triggering method by means of square wave or trapezoidal output voltage is particularly advantageous with regard to the low circuit expenditure thus achieved and the low power loss in the power output stage T17, T18 of the power amplifier 2.

Also a costly regulation of the transmitting power and use in a power output stage for each transmitting stage or each transmitting branch is not necessary. The reason for this is that the output stage T17, T18 of the power amplifier 2 is operated in saturated manner and, therefore, in the output stage driver T15, T16 only low power loss occurs. Moreover, the transmitter current I_{LF} can be regulated by means of pulse width modulation, what further reduces the circuit expenditure. The fact that the antennas LF_{1 . . . n} can be connected directly to the outlet LFₒᵤₜ of the power amplifier 2 results in that a plurality of transmitters can be triggered from a central control device. Here, the triggering expenditure is reduced in particular also by the use of a power multiplexer 4.

List of Reference Numerals

1 Transmitting device
2 Amplifier
4 Multiplexer
6 Ground branch
8 Shunt
10 Current regulation
12 Current detector/comparator
14 Control logistics
16 AND-gate
18 Sequential circuit/PWM-latch
AZₙ Antenna branch
B Buffer
C Condenser
D Diode
Eₙ Input
E_{ebl} ENABLE-input
HS_{diag} Diagnosis signal
LFₙ Transmitter antenna
LS_{diag} Diagnosis signal
I_{LF} Transmitter current/actual value
I_{Ref} Referential current/desired value
Lₙ Transmitter coil
LFₙ Transmitter antenna
LFₒᵤₜ Outlet
LF_{clk} Clock signal
M_{c} Control signal
Pᵢₙ Control input
R Resistance
S_{T} Trigger signal
SS Current mirror
T Transistor/MOSFET
U_{B} Operating voltage
VH Supply voltage/potential

1-8. (canceled)

9. A method for operating a transmitting device of an access system with a plurality of long wave antennas, the method comprising:
jointly triggering the long wave antennas by a central power amplifier;
individually activating the long wave antennas by a multiplexer device; and
regulating a transmitter current.

10. A method according to claim 9 further comprising:
detecting an actual value of the transmitter current is detected and if a desired value is exceeded, the transmitter current is approximated to the desired value by pulse-width modulation of an input signal of the central power amplifier.

11. A method according to claim 9, wherein the power amplifier is utilized to generate (2) a square wave or trapezoidal output voltage (LFₒᵤₜ) for triggering the long wave antennas.

12. A transmitting device for an access system, comprising:
a plurality of long wave antennas;
a multiplexer device for activating at least one long wave antenna;
a joint amplifier device having an output, wherein the long wave antennas are jointly connected; and
a control unit (10) for regulating a transmitter current.

13. A transmitting device according to claim 12 further comprising:
a device for detecting an actual value of the transmitter current; and
a control unit for pulse-width modulation of an input signal of the amplifier device, wherein the control unit initiates the transmitter current to approximate a desired value, if the desired value is exceeded.

14. A transmitting device according to claim 13 further comprising:
the control unit (10) is utilized to limit the transmitter current connected upstream to the joint amplifier device on the input side and downstream to the multiplexer unit.

15. A transmitting device according to one of claim 14 further comprising:
a control device (14), connected on the output side to a control input of the joint amplifier device, wherein the control device comprises a first input for a clock signal and second input for a control signal.

16. A transmitting device according to claim 15, in which the control device (14) comprises a logical combination element (16) with a first input for the clock signal and with a second input connected to a comparator (12) is connected on the output side via a sequential circuit (18), wherein the sequential circuit (18) is provided as a controlled latch-flipflop for pulse-width modulation of a control input signal (Pᵢₙ) of the joint amplifier device.
